(19) United States
(12) Patent Application Publication
(10) Pub. No.: US 2023/0162421 A1
(43) Pub. Date: May 25, 2023

(54) Dance Animation Processing Method and Apparatus, Electronic Device, and Storage Medium

(71) Applicant: NETEASE (HANGZHOU) NETWORK CO.,LTD., Hangzhou, Zhejiang (CN)

(72) Inventors: Zhipeng TAN, Hangzhou, Zhejiang (CN); Kang CHEN, Hangzhou, Zhejiang (CN); Weidong ZHANG, Hangzhou, Zhejiang (CN)

(21) Appl. No.: 17/778,040

(22) PCT Filed: Mar. 30, 2020
(86) PCT No.: PCT/CN2020/082055

§ 371 Date: Nov. 21, 2022

(30) Foreign Application Priority Data
Dec. 31, 2019 (CN) 201911419702.2

(51) Int. Cl. G06T 13/40; G06T 13/20; G06V 10/762; G06V 10/84

(52) U.S. Cl. CPC G06T 13/40; G06T 13/205; G06V 10/85; G06V 10/762

(57) ABSTRACT

The present disclosure provides a dance animation processing method and apparatus, an electronic device, and a storage medium. The method includes: acquiring multiple dance action segments, and establishing an animation state transition relationship for the multiple dance action segments, each action node in the animation state transition relationship corresponding to one dance action segment, and a transition cost existing among the action nodes; acquiring a target audio file, and determining a music feature sequence for the target audio file; determining a dance action sequence for the music feature sequence according to the transition cost in the animation state transition relationship; and generating a dance animation for the target audio file according to the dance action sequence.

### CROSS-REFERENCE TO RELATED APPLICATION

The present disclosure claims benefit of Chinese Patent Application No. 201911419702.2, filed to the China National Intellectual Property Administration on December, 31, 2019, entitled “Dance Animation Processing Method and Apparatus, Electronic Device and Storage Medium”, the disclosure of which is hereby incorporated by reference in its entirety.

### TECHNICAL FIELD

The present disclosure relates to the technical field of animation processing, and more particularly, to a dance animation processing method and apparatus, an electronic device, and a storage medium.

### BACKGROUND

Music and dance have always been two inseparable artistic forms. In game application, dance animations may be made for virtual game characters in games according to music such as popular songs.

In the related art, dance animations are usually made in the modes of action capture, manual animation (manual K frames) by an animator and the like. In these modes, the dance animation production period is long, the production cost is high, and the matching degree between the dance animation which is difficult to produce and music is not high.

### SUMMARY

In view of the above problems, a dance animation processing method and apparatus, an electronic device, and a storage medium are provided in order to overcome the above problems or at least partially solve the above problems.

A dance animation processing method may include that:
multiple dance action segments are acquired, and an animation state transition relationship/diagram for the multiple dance action segments is established, each action node in the animation state transition relationship/diagram corresponding to one dance action segment, and a transition cost existing among the action nodes;
a target audio file is acquired, and a music feature sequence for the target audio file is determined, the music feature sequence including multiple music feature segments;
a dance action sequence for the music feature sequence is determined according to the transition cost in the animation state transition diagram/relationship, the dance action sequence including multiple dance action segments, and each dance action segment corresponding to one music feature segment; and
a dance animation for the target audio file is generated according to the dance action sequence.

Optionally, the operation that a dance action sequence for the music feature sequence is determined according to the transition cost in the animation state transition diagram/relationship may include that:
a Hidden Markov Model (HMM) is preset;
the action node in the animation state transition diagram/relationship as a hidden state and the music feature sequence as an observable state are input into the HMM; and
a dance action sequence for the music feature sequence output by the HMM is acquired.

Optionally, the HMM may generate the dance action sequence for the music feature sequence according to the following manners:
a minimum cost corresponding to each action node in the animation state transition diagram/relationship and a minimum cost path corresponding to the minimum cost are determined, when the Nth music feature segment is generated, wherein N is a positive integer greater than 1, and the minimum cost path including one or more action nodes;
when the Nth music feature segment is the last music feature segment, the minimum costs corresponding to the action nodes are compared to obtain a target action node; and
a dance action sequence for the music feature sequence is generated according to the minimum cost path corresponding to the target action node.

Optionally, the operation that a minimum cost corresponding to each action node in the animation state transition diagram/relationship and a minimum cost path corresponding to the minimum cost are determined, when the Nth music feature segment is generated may include that:
for each action node in the animation state transition diagram/relationship, a matching cost corresponding to the Nth music feature segment is determined as a first cost score;
a transition cost of any action node in the animation state transition diagram/relationship relative to the action node is determined as multiple second cost scores;
a minimum cost corresponding to each action node in the animation state transition diagram/relationship is acquired as a third cost value when the N-1th music feature segment is generated;
the multiple overall costs are obtained according to the first cost score, the multiple second cost scores and the third cost score; and
a minimum overall cost is determined as a minimum cost of the action node, and a minimum cost path corresponding to the minimum cost is determined.

Optionally, the operation that the multiple overall costs are obtaining according to the first cost score, the multiple second cost scores and the third cost score may include that:
a penalty cost is determined as a fourth cost score when a repeatability constraint is met currently; and
the overall costs are obtained according to the first cost score, the multiple second cost scores, the third cost score and the fourth cost score.

Optionally, the repeatability constraint may include:
dance action segments corresponding to at least two identical music feature segments are different;
or, dance action segments corresponding to at least two different music feature segments are identical within a preset interval range.

Optionally, the matching cost may include an intensity matching cost, and/or a duration matching cost, and/or a style matching cost, and the operation that a matching cost with the Nth music feature segment is determined may include at least one of the followings:
an action intensity of the dance action segment corresponding to the action node and a music intensity of the Nth music feature segment are determined;
an intensity matching cost corresponding to the Nth music feature segment is determined according to the action intensity and the music intensity;
and/or, an action duration of the dance action segment corresponding to the action node and a music duration of the Nth music feature segment are determined;
a duration matching cost corresponding to the Nth music feature segment is determined according to the action duration and the music duration;
and/or, an action style of the dance action segment corresponding to the action node and a music style of the Nth music feature segment are determined; and
a style matching cost corresponding to the Nth music feature segment is determined according to the action style and the music style.

Optionally, the dance action segment may include a first dance action segment and a second dance action segment, the first dance action segment may correspond to music style information, and the action style may be determined by adopting the following:
an action style of the first dance action segment is determined according to the music style information;
the first dance action segment is clustered according to the action style to obtain multiple action clusters; and
a target action cluster corresponding to the second dance action segment is determined, and an action style corresponding to the target action cluster is taken as an action style of the second dance action segment.

Optionally, the operation that an animation state transition relationship for the multiple dance action segments is established may include that:
action nodes corresponding to the multiple dance action segments are established;
a transition cost existing among the action nodes is determined; and
the animation state transition relationship for the plurality of dance action segments according to a connection relationship is obtained, the connection relationship is established between the action nodes whose transition cost is larger than a preset transition cost.

Optionally, the operation that a dance animation for the target audio file is generated according to the dance action sequence may include that:

when footsteps of the dance action segments in the dance action sequence are in a specified state, footstep correction is performed on the dance action segments.

The specified state may include:

both feet slide on the ground, or one foot slides on the ground while the other foot is not fixed on the ground.

Optionally, the method may further include that:
original dance action data is acquired; and
action rhythm point features in the original dance action data are determined, and the original dance action data is segmented according to the action rhythm point features to obtain multiple dance action segments.

Optionally, the action rhythm point features may include any one or more of the following:

a joint weighted angular velocity curve, a joint trajectory curve, and a footstep height curve.

Optionally, the original dance action data may include first original dance action data and second original dance action data, and the operation that original dance action data is acquired may include that:
first original dance action data is acquired; and
action expansion is performed according to the first original dance action data to obtain second original dance action data.

Optionally, the action expansion may be performed by adopting the following manners:

action mirroring, action fusion and action curve control.

A dance animation processing apparatus may include:
an animation state transition relationship establishment component, configured to acquire multiple dance action segments, and establish an animation state transition diagram/relationship for the multiple dance action segments, each action node in the animation state transition diagram/relationship corresponding to one dance action segment, and a transition cost existing among the action nodes;
a music feature sequence determination component, configured to acquire a target audio file, and determine a music feature sequence for the target audio file, the music feature sequence including multiple music feature segments;
a dance action sequence determination component, configured to determine a dance action sequence for the music feature sequence according to the transition cost in the animation state transition diagram/relationship, the dance action sequence including multiple dance action segments, and each dance action segment corresponding to one music feature segment; and
a dance animation generation component, configured to generate a dance animation for the target audio file according to the dance action sequence.

An electronic device may include a processor, a memory and a computer program that is stored on the memory and runnable on the processor. The computer program, when executed by the processor, may implement the steps of the dance animation processing method as described above.

A computer-readable storage medium may have a computer program stored thereon. The computer program, when executed by a processor, may implement the steps of the dance animation processing method as described above.

The embodiments of the present disclosure have the following advantages:

In the embodiments of the present disclosure, multiple dance action segments are acquired, and an animation state transition relationship for the multiple dance action segments is established, each action node in the animation state transition relationship corresponding to one dance action segment, and a transition cost existing among the action nodes; a target audio file is then acquired, and a music feature sequence for the target audio file is determined, the music feature sequence including multiple music feature segments; a dance action sequence for the music feature sequence is determined according to the transition cost in the animation state transition relationship, the dance action sequence including multiple dance action segments, and each dance action segment corresponding to one music feature segment; and a dance animation for the target audio file is generated according to the dance action sequence. The production of dance animations is realized, the matching degree of the produced dance animations and music is improved, the production period is shortened, and the production cost is reduced.

### BRIEF DESCRIPTION OF THE DRAWINGS

In order to more clearly illustrate the technical solutions of the present disclosure, the drawings used in the description of the present disclosure will be briefly described below. It is apparent that the drawings in the following description are some embodiments of the present disclosure, and other drawings can be obtained from those skilled in the art according to these drawings without any creative work.

FIG. 1 is a step flowchart of a dance animation processing method according to one embodiment of the present disclosure;

FIG. 2a is a schematic diagram of a graphical user interface according to one embodiment of the present disclosure;

FIG. 2b is a schematic diagram of another graphical user interface according to one embodiment of the present disclosure;

FIG. 3 is a schematic diagram of a dance animation processing instance according to one embodiment of the present disclosure;

FIG. 4a is a schematic diagram of an animation state transition relationship according to one embodiment of the present disclosure;

FIG. 4b is a schematic diagram of model processing according to one embodiment of the present disclosure;

FIG. 4c is a schematic diagram of style clustering according to one embodiment of the present disclosure;

FIG. 4d is a schematic diagram of a model processing instance according to one embodiment of the present disclosure;

FIG. 5 is a step flowchart of another dance animation processing method according to one embodiment of the present disclosure;

FIG. 6a is a schematic diagram of a human skeleton according to one embodiment of the present disclosure;

FIG. 6b is a schematic diagram of action segmentation according to one embodiment of the present disclosure; and

FIG. 7 is a schematic structural diagram of a dance animation processing apparatus according to one embodiment of the present disclosure.

### DETAILED DESCRIPTION OF THE EMBODIMENTS

In order to make the above objects, features and advantages of the present disclosure become more apparent and understood, the present disclosure is further described in detail below with reference to the drawings and specific implementation manners. It is apparent that the described embodiments are a part of the embodiments of the present disclosure, not all of the embodiments. On the basis of the embodiments of the present disclosure, all other embodiments obtained on the premise of no creative work of those of ordinary skill in the art should fall within the scope of protection of the present disclosure.

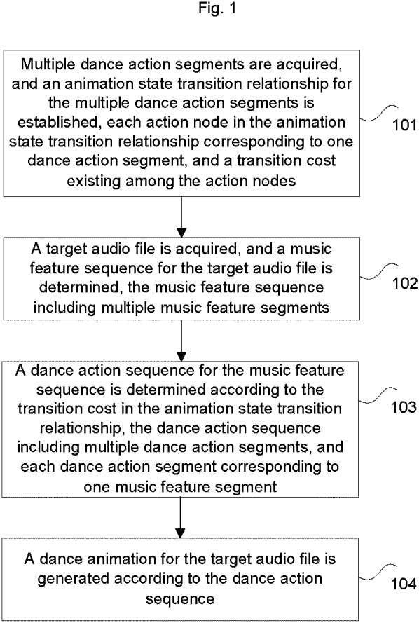

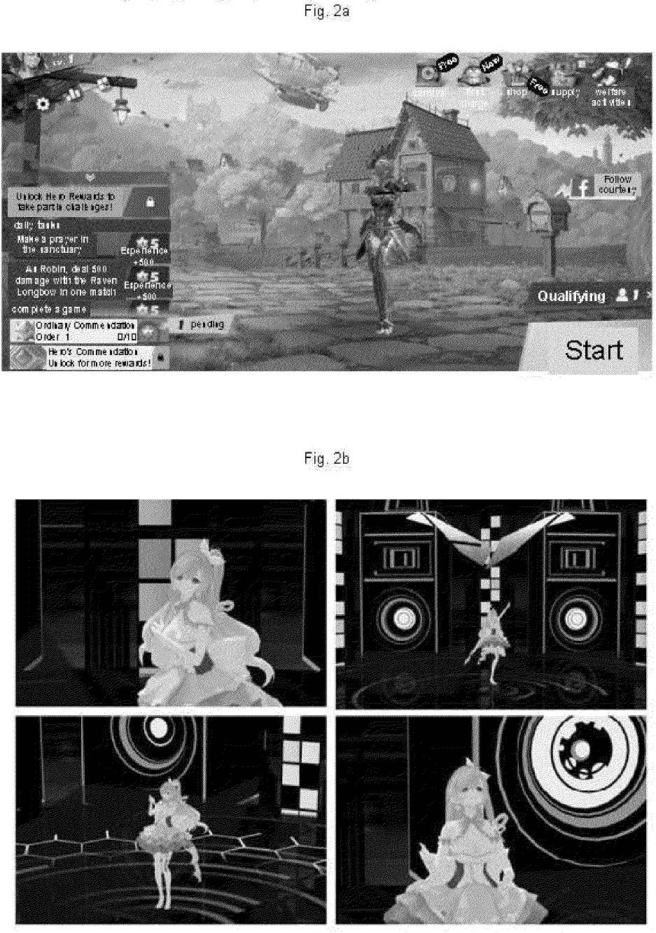

Referring to FIG. 1, a step flowchart of a dance animation processing method according to one embodiment of the present disclosure is shown. The method may be applied to a game, such as FIG. 2a, which may make a dance animation for a virtual game character in the game, but may of course also be applied to other aspects, such as FIG. 2b, applied to live broadcast, which may make a dance animation for a virtual live object.

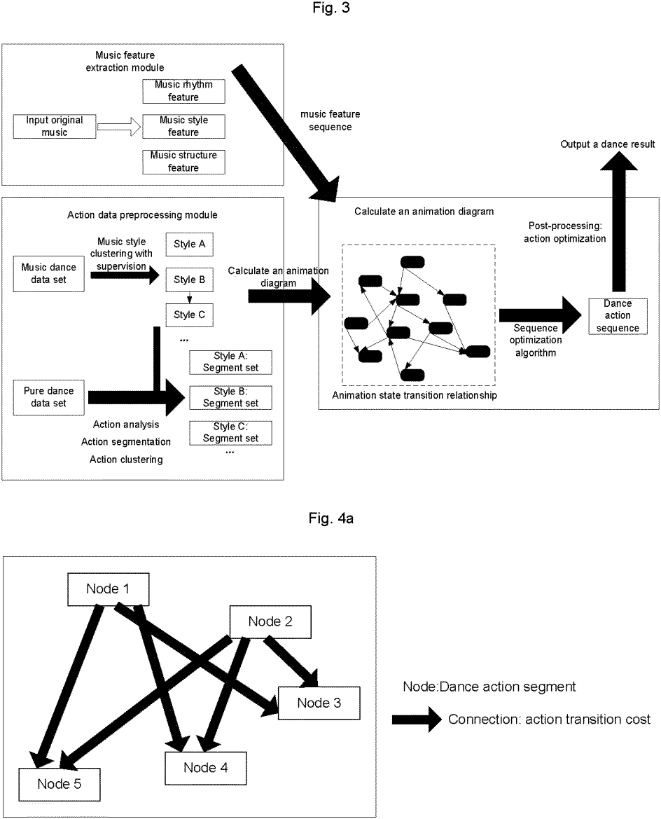

By the following description, taken in conjunction with FIG. 3, the method may specifically include the following steps:

In step 101, multiple dance action segments are acquired, and an animation state transition relationship for the multiple dance action segments is established. Each action node in the animation state transition relationship corresponds to one dance action segment, and a transition cost exists among the action nodes.

Multiple action nodes may exist in the animation state transition relationship, each action node may correspond to one dance action segment, and a transition cost exists between the action nodes. The corresponding dance action segments and the transition cost between other action nodes may be stored in the action nodes of the animation state transition relationship, and the transition cost may represent a value consumed when the two dance action segments are transited.

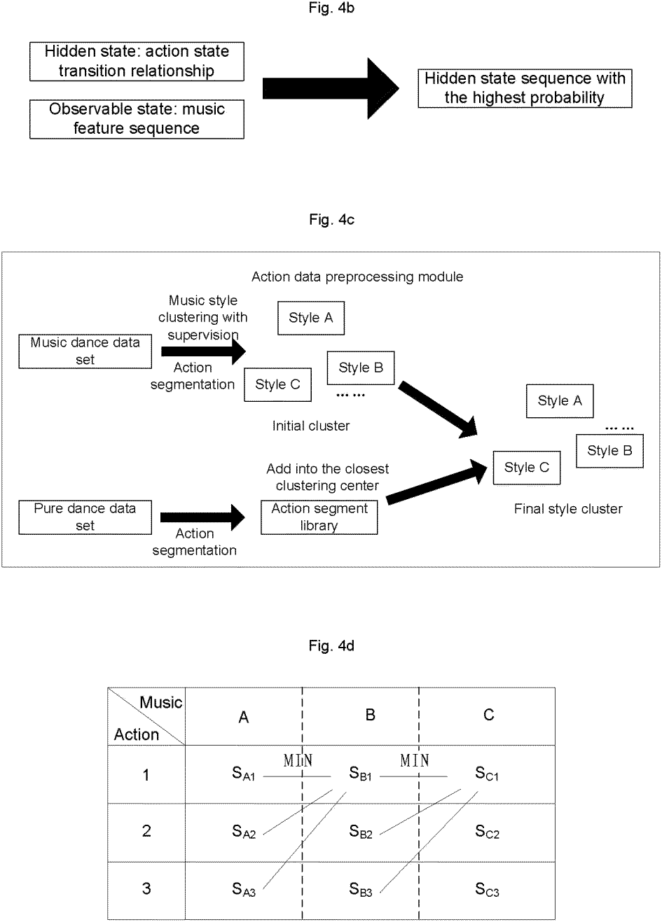

In practical application, an action data preprocessing module in FIG. 3 may acquire multiple dance action segments in advance, the transition cost between the dance action segments may be calculated, then an action node may be established for each dance action segment, and an animation state transition relationship containing multiple action nodes is constructed according to the transition cost. The animation state transition relationship may be in the form of a graph data structure, a table, a database and the like. FIG. 4a shows an animation state transition relationship in the form of a graph data structure, i.e. an animation state transition diagram. The animation state transition diagram includes action nodes and a connecting line connected between the action nodes. The connecting line represents a transition cost between two action nodes.

In step 102, a target audio file is acquired, and a music feature sequence for the target audio file is determined. The music feature sequence includes multiple music feature segments.

In the process of making a dance animation, a music feature extraction module in FIG. 3 may acquire a target audio file of the dance animation to be made and analyze the target audio file. Music features may be specifically analyzed from the aspects of music rhythm, music structure, music style and the like, to determine a music feature sequence for the target audio file. And the music feature sequence may include multiple music feature segments.

In step 103, a dance action sequence for the music feature sequence is determined according to the transition cost in the animation state transition relationship. The dance action sequence includes multiple dance action segments, and each dance action segment corresponds to one music feature segment.

Since the animation state transition relationship is constructed in advance, after the music feature sequence is obtained, a dance action synthesis module in FIG. 3 may generate a dance action sequence for the music feature sequence according to the transition cost in the animation state transition relationship.

In one embodiment of the present disclosure, step 103 may include the following sub-steps:

An HMM is preset, and the action node in the animation state transition relationship as a hidden state and the music feature sequence as an observable state are input into the HMM, and a dance action sequence for the music feature sequence output by the HMM is acquired.

The HMM is a double random process, the hidden states of the HMM cannot be observed directly, only the information of observable states may be obtained. The hidden states have own transition probabilities, and each observable state corresponds to each hidden state with a certain probability.

When synthesizing a dance action, as shown in FIG. 4b, the hidden state may be each action node in an action state transition diagram. The transition cost among the action nodes represents a transition probability between the hidden states (as the action transition cost is higher, the transition probability is lower). And a music feature sequence may be an observable state, and the matching cost of music features and action features is the probability of the observation state corresponding to each hidden state (as the matching cost of music and actions is lower, the corresponding probability is higher).

When the method is applied to the embodiments of the present disclosure, the action node in the animation state transition relationship as a hidden state and the music feature sequence as an observable state are input into the HMM, and after the model is processed, a dance action sequence for the music feature sequence output by the HMM may be acquired.

In one embodiment of the present disclosure, the HMM model, when an observation sequence is given, may optimize the most probable hidden state sequence by a probability maximizing method, and then a dynamic programming algorithm, such as a Viterbi algorithm, may be combined. The dynamic programming algorithm utilizes the local shortest path features. That is, when the sequence with the length of N is solved, only the path with the length of N-1 of the found optimal solution is considered. As a result, an approximate enumeration optimization method is avoided, and the animation synthesis time is reduced.

Specifically, the HMM may generate the dance action sequence for the music feature sequence according to the following manners:

In sub-step 11, a minimum cost corresponding to each action node in the animation state transition relationship and a minimum cost path corresponding to the minimum cost are determined when the Nth music feature segment is generated. N is a positive integer greater than 1, and the minimum cost path includes one or more action nodes.

Since the music feature sequence may include multiple music feature segments and has a certain time sequence, for the Nth music feature segment, each action node in the animation state transition relationship may be analyzed, a minimum cost when the action node is selected is determined, and then a minimum cost path of each action node during the Nth music feature segment may be determined.

In one embodiment of the present disclosure, sub-step 11 may include the following sub-steps:

In sub-step 111, for each action node in the animation state transition relationship, a matching cost corresponding to the Nth music feature segment is determined as a first cost score.

During the Nth music feature segment, for each action node in the animation state transition relationship, a matching cost corresponding to the Nth music feature segment may be determined as a first cost score.

In one embodiment of the present disclosure, the matching cost may include an intensity matching cost, and/or a duration matching cost, and/or a style matching cost, and step 111 may include the following sub-steps:

An action intensity of the dance action segment corresponding to the action node and a music intensity of the Nth music feature segment are determined; and an intensity matching cost corresponding to the Nth music feature segment is determined according to the action intensity and the music intensity.

And/or, an action duration of the dance action segment corresponding to the action node and a music duration of the Nth music feature segment are determined; and a duration matching cost corresponding to the Nth music feature segment is determined according to the action duration and the music duration.

And/or, an action style of the dance action segment corresponding to the action node and a music style of the Nth music feature segment are determined; and a style matching cost corresponding to the Nth music feature segment is determined according to the action style and the music style.

Specifically, the matching cost may be analyzed from the aspects of an action intensity and a music intensity, an action duration and a music duration, an action style and a music style, respectively.

For example, it is assumed that a music segment sequence obtained by rhythm analysis of a target audio file is {M₀, M₂, ... M_{N-1}} each music feature segment Mᵢ contains information such as a segment duration, a music intensity value and a music style of the music feature segment. All dance actions segments in the animation state transition relationship are {S₀, S₂, ... S_{M-1}} and the matching cost of music and dance segments is determined by the following formula:

$$\begin{matrix}\text{E} \left({\text{M}}_{\text{i}} , {\text{S}}_{\text{j}}\right) = \text{c} ⋅ {\text{e}}^{\text{a} \left|\text{Intensity} \left({\text{M}}_{\text{i}}\right) - \text{Intensity} \left({\text{S}}_{\text{j}}\right)\right|} + \\ \text{d} ⋅ {\text{e}}^{\text{b} \left|\text{Time} \left({\text{M}}_{\text{i}}\right) - \text{Time} \left({\text{S}}_{\text{j}}\right)\right|} + \text{StyleCost}\end{matrix}$$

In the above formula, parameters a, b, c, and d are adjustment coefficients. Intensity(Mᵢ) represents the intensity of a music segment, Intensity(Sⱼ) is an action intensity of a dance segment, and Intensity(Mᵢ) and Intensity(Sⱼ) are normalized to the same interval. Time(Mᵢ) and Time(Sⱼ) are the duration of a music segment and the duration of a dance animation, respectively.

The first term of the formula may be used for measuring the matching degree of the dance and the music strength, namely an intensity matching cost, by which the music segment corresponding to a larger rhythm intensity can be controlled to be matched with the dance with a larger action intensity.

The second term of the formula measures the closeness between the duration of the dance segment and the duration of the music segment, namely a duration matching cost. And as the two durations are closer, the cost of pulling the dance segment in time is smaller.

Moreover, according to an exponential function, the non-linearity is utilized, the matching cost between segments with closer intensities is less, and once the difference of the segments becomes slightly larger, the matching cost increases rapidly.

StyleCost of the third term of the formula is mainly used for constraining the consistency of dance and music styles, namely the cost of repeatability constraints (described in more detail below). If the music style is inconsistent with the action style, StyleCost is a larger style cost penalty value, otherwise the term is zero.

In one embodiment of the present disclosure, the dance action segment may include a first dance action segment and a second dance action segment, the first dance action segment corresponds to music style information, and the action style may be determined according to the following manners:

an action style of the first dance action segment is determined according to the music style information; the first dance action segment is clustered according to the action style to obtain multiple action clusters; and a target action cluster corresponding to the second dance action segment is determined, and an action style corresponding to the target action cluster is taken as an action style of the second dance action segment.

In practical application, as shown in FIG. 4c, some dance action data sets of an open source on a network and dance action data collected by some animators through hand K or action capture may be acquired. Some dance actions have corresponding music data, and others are pure action data.

For a first dance action segment with corresponding music data, music style information of the music data may be used to determine an action style of the first dance action segment, and then the first dance action segment is clustered to obtain multiple action clusters, namely an initial cluster in FIG. 4c.

For a second dance action segment of pure action data, a target action cluster corresponding to the second dance action segment may be determined and added to the nearest cluster center, and then an action style corresponding to the target action cluster may be taken as an action style of the second dance action segment.

In sub-step 112, a transition cost of any action node in the animation state transition relationship relative to the action node is determined as multiple second cost scores.

Since the transition cost between the actions is stored in the animation state transition relationship in advance, for a current action node, a transition cost of any action node in the animation state transition relationship relative to the action node may be determined, and then multiple second cost scores may be obtained.

In sub-step 113, a minimum cost corresponding to each action node in the animation state transition relationship is acquired as a third cost value when the N-1th music feature segment is generated.

For the Nth music feature segment, a minimum cost corresponding to each action node in the animation state transition relationship may be acquired as a third cost value when the N-1 th music feature segment is generated.

In sub-step 114, the multiple overall costs are obtained according to the first cost score, the multiple second cost scores and the third cost score.

The first cost score, the multiple second cost scores and the third cost score are obtained, and the various cost scores may be accumulated to obtain multiple overall costs.

In one embodiment of the present disclosure, sub-step 114 may include the following sub-steps:

A penalty cost is determined as a fourth cost score when a repeatability constraint is met; and an overall cost is obtained according to the first cost score, the multiple second cost scores, the third cost score and the fourth cost score.

The repeatability constraint may include the following content:

dance action segments corresponding to at least two identical music feature segments are different; or, dance action segments corresponding to at least two different music feature segments are identical within a preset interval range.

If dance action segments corresponding to at least two identical music feature segments are different, or, dance action segments corresponding to at least two different music feature segments are identical within a preset interval range, this case is to be discarded, and a penalty cost may be determined as a fourth cost score, thereby improving the overall cost.

In sub-step 115, a minimum overall cost is determined as a minimum cost of the action node, and a minimum cost path corresponding to the minimum cost is determined.

After multiple overall costs are determined, each overall cost corresponds to one path, a minimum cost of the minimum overall cost may be determined, and then a minimum cost path corresponding to the minimum cost may be determined.

It is to be noted that when the N-1th music feature segment is the first music feature segment, since there is no action transition, the minimum cost is the own matching cost.

In sub-step 12, when the Nth music feature segment is the last music feature segment, the minimum costs corresponding to the action nodes are compared to obtain a target action node.

When the last music feature segment is analyzed, the minimum cost corresponding to each action node under the music feature segment may be compared, and the action node corresponding to the minimum cost therein may be determined as a target action node.

In sub-step 13, a dance action sequence for the music feature sequence is generated according to the minimum cost path corresponding to the target action node.

After the target action node is determined, the minimum cost path corresponding to the minimum cost of the target action node may be obtained, and then a dance action sequence for the music feature sequence is generated according to a dance action segment corresponding to the action node in the path.

The above process is described below in conjunction with specific formulas:

It is assumed that a music segment sequence obtained by music rhythm segmentation is {M₀,M₂, ... M_{N-1}} it is necessary to allocate a dance action sequence

$$\left\{{\text{S}}_{{\text{n}}_{\text{0}}} , {\text{S}}_{{\text{n}}_{\text{2}}} , … {\text{S}}_{{\text{n}}_{\text{N} - 1}}\right\}$$

{Sₙ₀, Sₙ₂, ... S_{nN-1}} with a corresponding length, and the matching cost of the allocated action and the music segment is expected to be as small as possible. Meanwhile, the transition cost between the action segments is as small as possible, and repeated actions are avoided as much as possible in a closer action sequence, i.e. it is expected to minimize a cost function (i.e. maximize the probability of the HMM):

$$min \text{O} \left(\text{n}\right) = α {\sum }_{\text{j} = 1}^{\text{N}} \text{E} \left({\text{M}}_{\text{j}} , {\text{S}}_{{\text{n}}_{\text{j}}}\right) + β {\sum }_{\text{j} = 2}^{\text{N}} \text{D} \left({\text{n}}_{\text{j} - 1} , {\text{n}}_{\text{j}}\right) + γ {\sum }_{\text{j} = 2}^{\text{N}} \text{R} \left({\text{n}}_{\text{j}}\right)$$

In the formula, α, β, and y are specific gravity adjustment parameters. E(Mⱼ,

$$\left({\text{S}}_{{\text{n}}_{\text{j}}}\right)$$

is a matching cost function between a music segment and a dance segment

$${\text{S}}_{{\text{n}}_{\text{j}}} .$$

As the sum of the matching costs is smaller, the probability from an observation sequence of the HMM to a hidden state sequence is larger. And the matching degree between dance and music may be increased by optimizing the matching cost function.

D(nⱼ₋₁, nⱼ) is a transition cost stored in the animation state transition relationship. As the sum of the transition costs is smaller, the transition probability between hidden states of the HMM is larger. And the degree of fluency of the whole dance may be increased by optimizing the transition cost.

R(nⱼ) is a repeatability constraint term, which on the one hand prevents some action segments from appearing repeatedly in a short interval. lf nⱼ is repeated with the sequence and its previous states (it needs to be traced back along a parent node of a current optimal path during computation), a maximum penalty value is added. In addition, the backtracking of repeated detection has an upper limit of a backtracking length, which is set to maxLength.

$$\text{R} \left({\text{n}}_{\text{j}}\right) = \text{Max} \left({\text{if S}}_{{\text{n}}_{\text{j}}} = {\text{S}}_{{\text{n}}_{\text{i}}} , \text{for any i} < j a n d i > j - \text{maxLength}\right)$$

On the other hand, R(nⱼ) will also be used to constrain the occurrence of the same action sequence where the music is repeated (given by structural features of the music), it is assumed that {Mᵢ, ... Mⱼ} and {Mₖ, ... M₁} are detected as repeated parts of the music, it may be required that {S_{nᵢ}, ... S_{nⱼ}} and {S_{nₖ}, ... S_{nₗ}}have consistent actions, otherwise the repeatability constraint is set to a maximum penalty value. That is:

$$\text{R} \left({\text{n}}_{\text{k}}\right) = \text{Max} \left({\text{if M}}_{\text{k}} = {\text{M}}_{\text{i}} {\text{and S}}_{{\text{n}}_{\text{k}}} \neq {\text{S}}_{{\text{n}}_{\text{i}}}\right)$$

By increasing certain constraints on the basis of the Viterbi algorithm, a dynamic programming algorithm may be obtained. A state variable is set to be State(i,j), which indicates that dance has been selected for music sequences with the length of i from M₀ to Mᵢ in a current state, the local matching cost when the last action state is Sⱼ is provided, and then a state transition equation is as follows:

$$\begin{matrix}\text{State} \left(\text{i, j}\right) = {\text{min}}_{\text{t} ∈ \text{adj} \left({\text{S}}_{\text{j}}\right)} \left(\text{State} \left(\text{i} - 1 , \text{t}\right) + α ⋅ \text{E} \left({\text{M}}_{\text{i}} , {\text{S}}_{\text{j}}\right) +\right) \\ \left(β ⋅ \text{D} \left({\text{n}}_{\text{t}} , {\text{n}}_{\text{j}}\right) + γ ⋅ \text{R} \left({\text{n}}_{\text{j}}\right)\right)\end{matrix}$$

$$\left(\text{i} = 1 , 2 … \text{N} - 1 , \text{j} = 0 , 1 , … \text{M} - 1\right)$$

The initial state is: State(0, j) = a . E(M₀,Sⱼ) (j = 0,1, ... M - 1)

The final required result is: min [symbol] State(N - 1, j) (j=0, 1, ...M - 1)

Here, adj(Sⱼ) in the above formula represents an incident neighboring edge set of state Sⱼ in the animation state transition relationship, so that the search range can be reduced. If the length of a music feature sequence is N (the length of an observation sequence is N) and the number of states of the action state transition diagram is D (i.e. the number of hidden states is D), the worst complexity of the algorithm (i.e. the whole state space is enumerated every time the minimum value is found) is 0(N∗D²). But since a parent node set is used and the animation is usually sparse, the actual complexity of the algorithm can be considered to be much lower than 0(N ∗ D²), and the actual complexity of the algorithm can be 0(p ∗ N ∗ D), p being the maximum number of parent nodes.

The above process is exemplified below in connection with FIG. 4d (for simplicity of illustration, the following process ignores the first cost score, i.e. the matching cost):

It is assumed that music feature segment A, music feature segment B and music feature segment C sequentially exist and dance action segment 1, dance action segment 2 and dance action segment 3 exist in a database.

When analyzing the first music feature segment A:

It may be determined that the minimum cost for dance action segment 1 is S_{A1}, the minimum cost for dance action segment 2 is S_{A2}, and the minimum cost for dance action segment 2 is S_{A3}.

When analyzing the second music feature segment B:

For dance action segment 1 (i.e. selecting dance action segment 1 from the second music feature segment B), the transition costs from each dance action segment to dance action segment 1 may be calculated respectively, and then the following three situations exist:

It transits from dance action segment 1 to dance action segment 1 (i.e. the first music feature segment A selects dance action segment 1, and the second music feature segment B selects dance action segment 1), thereby obtaining:

$$\text{Overall Cost 1} = {\text{S}}_{\text{A1}} + \text{Transition Cost 1}$$

Transition cost 1 serves as a second cost score, and S_{A1} serves as a third cost score.

It transits from dance action segment 2 to dance action segment 1 (i.e. the first music feature segment A selects dance action segment 2, and the second music feature segment B selects dance action segment 1), thereby obtaining:

$$\text{Overall Cost 2} = {\text{S}}_{\text{A2}} + \text{Transition Cost 2}$$

Transition cost 2 is a second cost score, and S_{A2} is a third cost score.

It transits from dance action segment 3 to dance action segment 1 (i.e. the first music feature segment A selects dance action segment 3, and the second music feature segment B selects dance action segment 1), thereby obtaining:

$$\text{Overall Cost 3} = {\text{S}}_{\text{A3}} + \text{Transition Cost 3}$$

Transition cost 3 serves as a second cost score, and S_{A3} serves as a third cost score.

After multiple overall costs are obtained, the sizes of the multiple overall costs may be compared, a minimum overall cost is determined, and minimum cost S_{B1}of dance action segment 1 is selected as the second music feature segment B:
S_{B1} = min (overall cost 1, overall cost 2, overall cost 3)
(Other dance actions segments are by parity of reasoning, and S_{B2} and S_{B3} may be calculated)

When analyzing the third music feature segment B:

In the above manner, S_{C1}, S_{C2} and S_{C3} may be calculated respectively. Since the third music feature segment B is the last music feature segment, the sizes of S_{c1}, S_{C2} and S_{C3} may be compared. It is assumed that S_{C1} is determined to be the smallest, a target action node for the third music feature segment C may be determined to be dance action segment 1. That is, it may be determined that the third music feature segment C selects dance action segment 1.

It is assumed that in the process of calculating minimum cost S_{c1}, it is determined that minimum cost S_{C1} is an overall cost when the second music feature segment B selects dance action segment 1 and the third music feature segment C selects dance action segment 1, and it may be determined that the second music feature segment B selects dance action segment 1.

It is assumed that in the process of calculating minimum cost S_{B1}, it is determined that minimum cost S_{B1} is an overall cost when the first music feature segment A selects dance action segment 1 and the second music feature segment B selects dance action segment 1, and it may be determined that the second music feature segment B selects dance action segment 1 and the first music feature segment A selects dance action segment 1.

In summary, the final dance action sequence may be obtained as the first music feature segment A corresponding to dance action segment 1, the second music feature segment B corresponding to dance action segment 1, and the third music feature segment C corresponding to dance action segment 1.

In step 104, a dance animation for the target audio file is generated according to the dance action sequence.

After the dance action sequence is obtained, a dance animation for the target audio file is generated according to the dance action sequence.

In the embodiments of the present disclosure, multiple dance action segments are acquired, and an animation state transition relationship for the multiple dance action segments is established, each action node in the animation state transition relationship corresponding to one dance action segment, and a transition cost existing among the action nodes; a target audio file is then acquired, and a music feature sequence for the target audio file is determined, the music feature sequence including multiple music feature segments; a dance action sequence for the music feature sequence is determined according to the transition cost in the animation state transition relationship, the dance action sequence including multiple dance action segments, and each dance action segment corresponding to one music feature segment; and a dance animation for the target audio file is generated according to the dance action sequence. The production of dance animations is realized, the matching degree of the produced dance animations and music is improved, the production period is shortened, and the production cost is reduced.

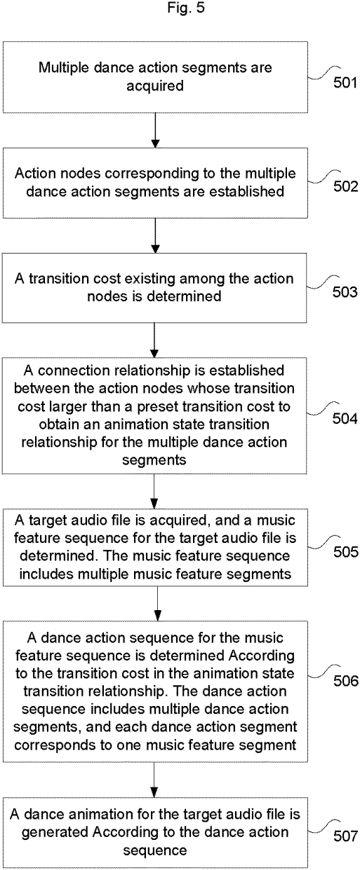

Referring to FIG. 5, a step flowchart of a dance animation processing method according to one embodiment of the present disclosure is shown. The method may specifically include the following steps:

In step 501, multiple dance action segments are acquired.

In one embodiment of the present disclosure, the method may further include the following steps:

Original dance action data is acquired; and action rhythm point features in the original dance action data are determined, and the original dance action data is segmented according to the action rhythm point features to obtain multiple dance action segments.

As an example, the action rhythm point features may include any one or more of the following:

a joint weighted angular velocity curve, a joint trajectory curve and a footstep height curve.

When a dance is enjoyed, the audience can naturally feel action rhythm points in the dance, and the dancer can call the rhythm of the music through various body rhythms. To synthesize the dance corresponding to the rhythm sense consistent with the music, the most basic thing is to detect the position of the rhythm points in the dance action. An action segment between the adjacent rhythm points is regarded as a basic dance posture, such as a hand beating action or a foot beating action. It is the basis of the following dance synthesis algorithm to divide the action into basic action segments at the rhythm point exactly.

The accuracy of the segmentation of rhythmic points of the dance action will directly affect the quality of the rhythm sensation of the final synthesized dance. However, due to various poses of actual dance actions and varied features of the action rhythm points, in order to improve the accuracy of action segmentation, multiple features are comprehensively utilized for analysis. These features include a joint weighted angular velocity curve, a hand action trajectory curve and a footstep height curve for comprehensive division.

By analyzing the weighted angular velocity curve, the hand action trajectory curve and the footstep height curve, a candidate set of multiple rhythm division points may be obtained. In actual segmentation, the weighted angular velocity curve is taken as the main part, the hand action trajectory curve and the footstep height curve are combined for supplementation, and midpoints of multiple closer rhythm division points are only taken for segmentation. In addition, for some complicated dance actions, if the automatic segmentation is not accurate enough, the segmentation position may be further corrected manually.

In addition, based on the action weighted angular velocity curve, an action intensity (cumulative average of angular velocity values) of each dance action segment may be continuously refined. The feature value may facilitate the matching calculation of subsequent music and actions.

For the joint weighted angular velocity curve:

Dance actions tend to have a brief pause at the rhythm, such as a common hand swing, when the hand swings from left to right and then to left, there will be a brief pause when the hand approaches the far left or the far right, that is. the angular velocity gradually approaches zero and then moves reversely. Therefore, the magnitude of the angular velocity of each joint per unit time (the magnitude of an angle rotated about one joint per unit time) needs to be calculated. Since a time interval between adjacent frames is short, it may be simplified to consider that the rotation angle value of adjacent frames is the angular velocity value. The local minimum point of the angular velocity curve is a candidate point of the action rhythm point.

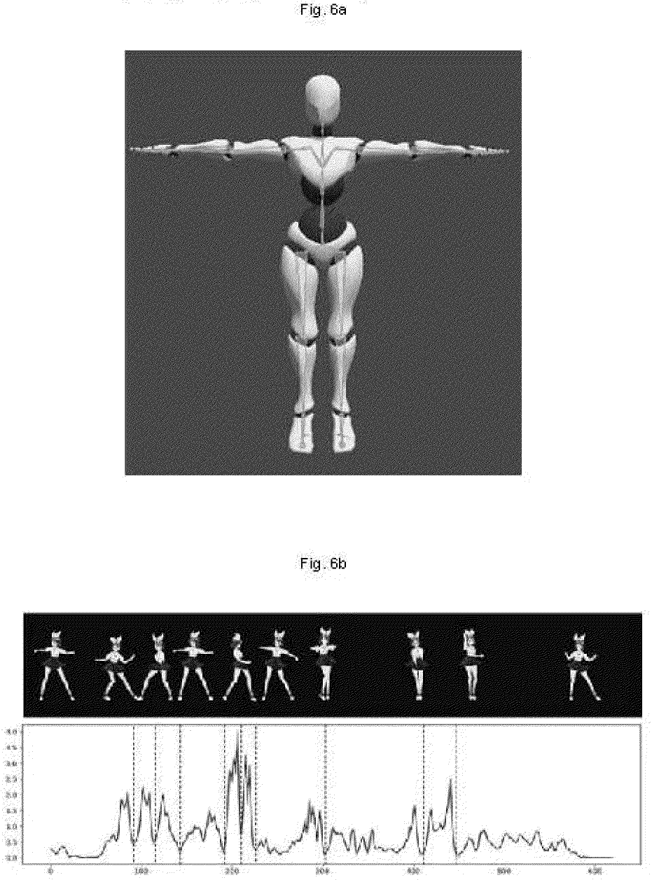

FIG. 6a is a human skeletal model diagram. It is assumed that vᵢ is the ith joint of a human body and Q(vᵢ,f) is the local rotation quaternion of the vᵢ joint in the fth frame.

The weighted angular velocity sum for a frame is calculated as follows. An Angle function is a basic function for calculating an included angle between two quaternions.

$${\text{a}}_{\text{i}}$$

is a weighting parameter because some bones have a greater impact on the action, such as arms and feet, and larger weighting parameters may be set to improve the impacts on the result.

$$\text{W} \left(\text{f}\right) = {\sum }_{\text{i}} {\text{a}}_{\text{i}} ⋅ \text{Angle} \left(\text{Q} \left({\text{v}}_{\text{i}} , \text{f}\right) , \text{Q} \left({\text{v}}_{\text{i}} , \text{f} + 1\right)\right)$$

A weighted angular velocity curve W(f) is calculated for each frame of a dance animation, and a candidate segmentation position can be obtained by detecting a minimum value point in the frame after proper smoothing. FIG. 6b is a segmentation result of an action according to the weighted angular velocity curve.

In one example, a minimum division length (the segments are not too short) and a minimum energy value may be set (if an overall energy value for a certain interval is low, division is not performed).

For the joint trajectory curve:

The position trajectory curves of some important joints in the dance action can also provide important information for rhythm point detection. For example, in an action of the hand stretching to the farthest and retracting, it is considered that the time when the hand reaches the farthest is a rhythm point of the action, so the trajectory information of both hands and feet is additionally considered, a distance curve of a joint trajectory from the origin of a model is analyzed. And when the distance curve reaches the maximum or minimum value, it is also considered to be a possible rhythm point position.

For the footstep height curve:

When there are steps or walks in dance, the place where the footsteps fall is considered to be the position of a rhythm point. Therefore, the trajectory analysis for both feet also adds a footstep height curve, which has a curve value of 0 when the footsteps fall and a curve value of a height from the footsteps to the ground when the footsteps rise. The time when the footsteps just fall is also considered to be a possible rhythm point position.

In one embodiment of the present disclosure, the original dance action data may include first original dance action data and second original dance action data, and the operation that original dance action data is acquired includes that:

first original dance action data is acquired; and action expansion is performed by adopting the first original dance action data to obtain second original dance action data.

As an example, the action expansion may be performed by adopting the following manners: action mirroring, action fusion and action curve control.

Action mirroring: the actions of the left and right parts of the body are mirrored, that is, the left hand performs the action of the right hand, and the left foot performs the action of the right foot, and so on.

Action fusion: the actions of the upper and lower parts of the body of similar styles are reorganized and fused, for example, the upper body action of one action and the lower limb action of another action are fused. This method cannot guarantee that new actions obtained by the fusion will have a sense of beauty, so some poor actions need to be screened out.

Action curve control: new actions of the same model are obtained by adjusting trajectory curves of some joints (mainly hands). For example, by raising the hand trajectory curve through an action of clapping hands on the chest, actions of clapping hands at different heights are obtained through an IK algorithm.

In one example, some filtering may be required for the expanded results to remove the problematic actions, which mainly includes two aspects. On the one hand, the collision detection of the actions is performed. If the bones of the expanded action collide with each other, the action is an action with an obvious problem that needs to be screened out. On the other hand, it is to detect whether the rotation range of each joint exceeds a normal range (such as whether the shoulder is rotated back), and if there is an abnormality, it will be directly screened out.

In step 502, action nodes corresponding to the multiple dance action segments are established.

In step 503, a transition cost existing among the action nodes is determined.

For two dance action segments i, j, D(i, j) is defined as the cost of the transition from dance action segment i to dance action segment j:

$$\text{D} \left(\text{i, j}\right) = {\sum }_{\text{k}} {\text{a}}_{\text{k}} ⋅ \text{Angle} \left({\text{Q}}_{\text{i}} \left({\text{v}}_{\text{k}} , \text{end}\right) , {\text{Q}}_{\text{j}} \left({\text{v}}_{\text{k}} , \text{begin}\right)\right)$$

Qᵢ(vₖ, end) represents the local rotation quaternion of the last frame of the vₖ joint of dance action segment i, and Qⱼ(vₖ, begin) is the local rotation quaternion of the vₖ joint in the starting frame of dance action segment j. This formula is derived by calculating the change in the weighted angular velocity W(f), where D(i, j) represents the cost of the transition from the end of a dance action segment to the beginning of another dance action segment, as well as the degree of engagement of the two action segments.

In step 504, the animation state transition relationship for the plurality of dance action segments according to a connection relationship is obtained. The connection relationship is established between the action nodes whose transition cost is larger than a preset transition cost.

The connection relationship is used for representing the possibility of transition between two action nodes. When the connection relationship does not exist, the transition between the two action nodes is impossible, that is, the transition between dance action segments corresponding to the two action nodes cannot be carried out. And only the action nodes with the connection relationship may form a path in the subsequent path determination process.

In a specific implementation, a connection relationship may be established between the action nodes with the transition cost larger than a preset transition cost. And a connection relationship may not be established for the action nodes with the transition cost larger than the preset transition cost, so that an animation state transition relationship for multiple dance action segments is obtained.

In one example, the action state transition diagram may be considered to be a K Nearest Neighbor (KNN) since the maximum number of connections per node may be set when constructing the diagram, that is, each state may establish a connection relationship with the K states with the lowest transition cost. The complexity of direct diagram construction is very high, and the time required is rapidly increased when the number of states is increased. So an approximate K-nearest neighbor algorithm based on a KD tree is adopted in order to accelerate the diagram construction speed.

In step 505, a target audio file is acquired, and a music feature sequence for the target audio file is determined. The music feature sequence includes multiple music feature segments.

In step 506, a dance action sequence for the music feature sequence is determined by combining the transition cost in the animation state transition relationship. The dance action sequence includes multiple dance action segments, and each dance action segment corresponds to one music feature segment.

In step 507, a dance animation for the target audio file is generated by adopting the dance action sequence.

In one embodiment of the present disclosure, step 507 may include the following steps:

When footsteps of the dance action segments in the dance action sequence are in a specified state, footstep correction is performed on the dance action segments.

The specified state may include:

both feet slide on the ground, or one foot slides on the ground while the other foot is not fixed on the ground.

Since a dance sequence obtained after action synthesis sometimes has the problem of footstep sliding, on the one hand. The problem of original action data or the problem of interpolation transition of different action segments may cause the problem of footstep sliding, and footstep correction may be performed to overcome the problem of footstep sliding.

Specifically, the interval of each footstep falling in the whole action sequence may be detected respectively. If one foot slides in the interval of falling, the condition of the other foot may be detected to decide whether to modify or not. If the other foot is fixed on the ground in the interval, the other foot is considered to be the fixed foot, and the action does not need to be modified; if the other foot is not on the ground or is also sliding on the ground, it is considered to perform footstep correction for this interval.

During correction, the foot which is on the ground and has small motion amplitude is selected to be corrected, the trajectory of the foot is fixed at a sliding midpoint position. And the front part and the rear part of the interval are transited to the position through interpolation and fixed, then the corrected footstep trajectory of the two feet is obtained, and corrected dance data may be obtained by processing the whole action sequence through the footstep IK.

It is to be noted that, for the method embodiments, for the sake of simple description, they are all expressed as a series of action combinations, but those skilled in the art should understand that the embodiments of the present disclosure are not limited by the described action sequence, because certain steps may be performed in other sequences or concurrently in accordance with the embodiments of the present disclosure. Secondly, those skilled in the art should also understand that the embodiments described in the specification are all preferred embodiments, and the actions involved are not necessarily required in the embodiments of the present disclosure.

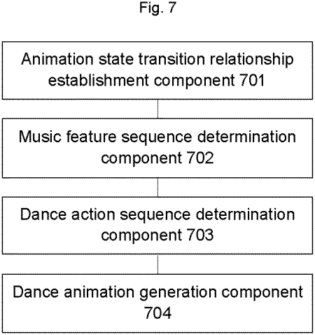

Referring to FIG. 7, a schematic structural diagram of a dance animation processing apparatus according to one embodiment of the present disclosure is shown. The apparatus may specifically include the following modules:
an animation state transition relationship establishment component 701, configured to acquire multiple dance action segments, and establish an animation state transition relationship for the multiple dance action segments, each action node in the animation state transition relationship corresponding to one dance action segment, and a transition cost existing among the action nodes;
a music feature sequence determination component 702, configured to acquire a target audio file, and determine a music feature sequence for the target audio file, the music feature sequence including multiple music feature segments;
a dance action sequence determination component 703, configured to determine a dance action sequence for the music feature sequence according to the transition cost in the animation state transition relationship, the dance action sequence including multiple dance action segments, and each dance action segment corresponding to one music feature segment; and
a dance animation generation component 704, configured to generate a dance animation for the target audio file according to the dance action sequence.

In one embodiment of the present disclosure, the dance action sequence determination component 703 includes:
a model presetting sub-component, configured to preset an HMM;
a model input sub-component, configured to input the action node in the animation state transition relationship as a hidden state and the music feature sequence as an observable state into the HMM; and
a model output sub-component, configured to acquire a dance action sequence for the music feature sequence output by the HMM.

In one embodiment of the present disclosure, the HMM generates the dance action sequence for the music feature sequence according to the following components:
a minimum cost and path determination component, configured to determine a minimum cost corresponding to each action node in the animation state transition relationship and a minimum cost path corresponding to the minimum cost, when generating the Nth music feature segment, wherein N is a positive integer greater than 1, and the minimum cost path comprising at least one action node;
a target action node obtaining component, configured to compare the minimum cost corresponding to each action nodes to obtain a target action node, when the Nth music feature segment is the last music feature segment; and
a dance action sequence generation component, configured to generate a dance action sequence for the music feature sequence according to the minimum cost path corresponding to the target action node.

In one embodiment of the present disclosure, the minimum cost and path determination component includes:
a first cost score serving sub-component, configured to determine, for each action node in the animation state transition relationship, a matching cost with the Nth music feature segment as a first cost score;
a second cost score serving sub-component, configured to determine a transition cost of any action node in the animation state transition relationship relative to the action node as multiple second cost scores;
a third cost score serving sub-component, configured to acquire a minimum cost corresponding to each action node in the animation state transition relationship when generating the N-1th music feature segment as a third cost value;
an overall cost obtaining sub-component, configured to obtain multiple overall costs according to the first cost score, the multiple second cost scores and the third cost score; and
a cost and path determination sub-component, configured to determine a minimum overall cost as a minimum cost of the action node, and determine a minimum cost path corresponding to the minimum cost.

In one embodiment of the present disclosure, the overall cost obtaining sub-component includes:
a fourth cost score serving unit, configured to determine a penalty cost as a fourth cost score when a repeatability constraint is met; and
a fourth cost score combining unit, configured to obtain an overall cost according to the first cost score, the multiple second cost scores, the third cost score and the fourth cost score.

In one embodiment of the present disclosure, the repeatability constraint includes:
dance action segments corresponding to at least two identical music feature segments are different;
or, dance action segments corresponding to at least two different music feature segments are identical within a preset interval range.

In one embodiment of the present disclosure, the matching cost includes an intensity matching cost, and/or a duration matching cost, and/or a style matching cost, and the first cost score serving sub-component includes:
an intensity determination unit, configured to determine an action intensity of the dance action segment corresponding to the action node and a music intensity of the Nth music feature segment;
an intensity cost determination unit, configured to determine an intensity matching cost corresponding to the Nth music feature segment according to the action intensity and the music intensity;
and/or, a duration determination unit, configured to determine an action duration of the dance action segment corresponding to the action node and a music duration of the Nth music feature segment;
a duration cost unit, configured to determine a duration matching cost corresponding to the Nth music feature segment according to the action duration and the music duration;
and/or, a style determination unit, configured to determine an action style of the dance action segment corresponding to the action node and a music style of the Nth music feature segment; and
a style cost determination unit, configured to determine a style matching cost corresponding to the Nth music feature segment according to the action style and the music style.

In one embodiment of the present disclosure, the dance action segment includes a first dance action segment and a second dance action segment, the first dance action segment corresponds to music style information, and the action style is determined by adopting the following manners:
an action style of the first dance action segment is determined according to the music style information;
the first dance action segment is clustered according to the action style to obtain multiple action clusters; and
a target action cluster corresponding to the second dance action segment is determined, and an action style corresponding to the target action cluster is taken as an action style of the second dance action segment.

In one embodiment of the present disclosure, the animation state transition relationship establishment component 701 includes:
an action node establishment sub-component, configured to establish action nodes corresponding to the multiple dance action segments;
a transition cost determination sub-component, configured to determine a transition cost existing among the action nodes; and
a connection relationship establishment sub-component, configured to obtain the animation state transition relationship for the plurality of dance action segments according to a connection relationship, which is established between the action nodes whose transition cost is larger than a preset transition cost.

In one embodiment of the present disclosure, the dance animation generation component 704 includes: a footstep correction sub-component, configured to perform, when footsteps of the dance action segments in the dance action sequence are in a specified state, footstep correction on the dance action segments.

The specified state includes:

both feet slide on the ground, or one foot slides on the ground while the other foot is not fixed on the ground.

In one embodiment of the present disclosure, the apparatus further includes:
an original dance action data acquisition component, configured to acquire original dance action data; and
an action segmentation component, configured to determine action rhythm point features in the original dance action data, and segment the original dance action data according to the action rhythm point features to obtain multiple dance action segments.

In one embodiment of the present disclosure, the action rhythm point features include any one or more of the following:

a joint weighted angular velocity curve, a joint trajectory curve and a footstep height curve.

In one embodiment of the present disclosure, the original dance action data includes first original dance action data and second original dance action data, and the original dance action data acquisition component includes:
a first original dance action data acquisition sub-component, configured to acquire first original dance action data; and
an action expansion sub-component, configured to perform action expansion according to the first original dance action data to obtain second original dance action data.

In one embodiment of the present disclosure, the action expansion is performed by adopting the following manners:

action mirroring, action fusion and action curve control.

One embodiment of the present disclosure also provides an electronic device, which may include a processor, a memory and a computer program that is stored on the memory and runnable on the processor. The computer program, when executed by the processor, implements the steps of the dance animation processing method as described above.

One embodiment of the present disclosure also provides a computer-readable storage medium, which has a computer program stored thereon. The computer program, when executed by a processor, implements the steps of the dance animation processing method as described above.

For the device embodiment, since it is basically similar to the method embodiment, the description is relatively simple, and the relevant parts can be referred to the description of the method embodiment.

Various embodiments in the present specification are described in a progressive manner, each embodiment focuses on differences from other embodiments, and the identical or similar parts between the various embodiments can be referred to each other.

A person skilled in the art should understand that the embodiments of the present disclosure may be provided as a method, an apparatus or a computer program product. Thus, the embodiments of the present disclosure may adopt forms of complete hardware embodiments, complete software embodiments or embodiments integrating software and hardware. Moreover, the embodiments of the present disclosure may adopt the form of a computer program product implemented on one or more computer available storage media (including, but not limited to, a disk memory, a CD-ROM, an optical memory and the like) containing computer available program codes.

The embodiments of the present disclosure are described with reference to flowcharts and/or block diagrams of the method, the terminal device (system) and the computer program product according to the embodiments of the present disclosure. It is to be understood that each flow and/or block in the flowcharts and/or the block diagrams and a combination of the flows and/or the blocks in the flowcharts and/or the block diagrams may be implemented by computer program instructions. These computer program instructions may be provided for a general computer, a dedicated computer, an embedded processor or processors of other programmable data processing terminal devices to generate a machine, so that an apparatus for achieving functions designated in one or more flows of the flowcharts and/or one or more blocks of the block diagrams is generated via instructions executed by the computers or the processors of the other programmable data processing terminal devices.

These computer program instructions may also be stored in a computer readable memory capable of guiding the computers or the other programmable data processing terminal devices to work in a specific mode, so that a manufactured product including an instruction apparatus is generated via the instructions stored in the computer readable memory, and the instruction apparatus achieves the functions designated in one or more flows of the flowcharts and/or one or more blocks of the block diagrams.

These computer program instructions may also be loaded to the computers or the other programmable data processing terminal devices, so that processing implemented by the computers is generated by executing a series of operation steps on the computers or the other programmable terminal devices, and therefore the instructions executed on the computers or the other programmable terminal devices provide a step of achieving the functions designated in one or more flows of the flowcharts and/or one or more blocks of the block diagrams.

While preferred embodiments of the embodiments of the present disclosure has been described, those skilled in the art can make additional changes and modifications to the embodiments once knowing a basic creativity concept. Therefore, the appended claims are intended to be interpreted as including the preferred embodiments and all the changes and modifications falling within the scope of the embodiments of the present disclosure.

Finally, it is also to be noted that relational terms such as first and second are used merely to distinguish one entity or operation from another entity or operation herein, and do not necessarily require or imply the existence of any such actual relationship or order between these entities or operations. Moreover, the terms “include”, “contain” or any other variations thereof are intended to cover a non-exclusive inclusion, such that a process, method, article or terminal device including a series of elements not only includes those elements, but also includes those elements that are not explicitly listed, or includes elements inherent to such a process, method, article or terminal device. Under the condition of no more limitations, it is not excluded that additional identical elements exist in the process, method, article or terminal device including elements defined by a sentence “including a ...”.

The above is a detailed description of a dance animation processing method and apparatus, an electronic device, and a storage medium provided herein. The principle and implementation manner of the present disclosure are described in the specific examples herein. The description of the embodiments is only for helping to understand the method of the present disclosure and its core ideas. Meanwhile, for those of ordinary skill in the art, according to the idea of the present disclosure, there will be changes in specific implementation manners and application scopes. In conclusion, the content of the description should not be taken as limiting the present disclosure.

### Industrial Applicability

The solution provided by the embodiments of the present disclosure may be applied to an animation processing aspect in a game scenario. An animation state transition relationship for multiple dance action segments is established, a music feature sequence for a target audio file is determined, a dance action sequence for the music feature sequence is determined by combining a transition cost in the animation state transition relationship, and finally a dance animation for the target audio file is generated by adopting the dance action sequence. The production of dance animations is realized, the matching degree of the produced dance animations and music is improved, the production period is shortened, and the production cost is reduced.

What is claimed is:

1. A dance animation processing method, comprising:
acquiring a plurality of dance action segments, and establishing an animation state transition relationship for the plurality of dance action segments, each action node in the animation state transition relationship corresponding to one dance action segment, and a transition cost existing among the action nodes in the animation state transition relationship;
acquiring a target audio file, and determining a music feature sequence for the target audio file, the music feature sequence comprising a plurality of music feature segments;
determining a dance action sequence for the music feature sequence according to the transition cost in the animation state transition relationship, the dance action sequence comprising a plurality of dance action segments, and each dance action segment corresponding to one music feature segment; and
generating a dance animation for the target audio file according to the dance action sequence.

2. The method as claimed in claim 1, wherein determining the dance action sequence for the music feature sequence according to the transition cost in the animation state transition relationship comprises:
presetting a Hidden Markov Model;
inputting the action node in the animation state transition relationship as a hidden state and the music feature sequence as an observable state into the Hidden Markov Model; and
acquiring the dance action sequence for the music feature sequence output by the Hidden Markov Model.

3. The method as claimed in claim 2, wherein the Hidden Markov Model generates the dance action sequence for the music feature sequence according to the following manners:
determining a minimum cost corresponding to each action node in the animation state transition relationship and a minimum cost path corresponding to the minimum cost, when generating the Nth music feature segment, wherein N is a positive integer greater than 1, and the minimum cost path comprising at least one action node;
in response to the Nth music feature segment being the last music feature segment, comparing the minimum cost corresponding to each action nodes to obtain a target action node; and
generating the dance action sequence for the music feature sequence according to the minimum cost path corresponding to the target action node.

4. The method as claimed in claim 3, wherein determining a minimum cost corresponding to each action node in the animation state transition relationship and a minimum cost path corresponding to the minimum cost, when generating the Nth music feature segment comprises:
Determining, for each action node in the animation state transition relationship, a matching cost corresponding to the Nth music feature segment as a first cost score;
determining a transition cost of any action node in the animation state transition relationship relative to the action node as a plurality of second cost scores;
acquiring a minimum cost corresponding to each action node in the animation state transition relationship when generating the N-1th music feature segment as a third cost value;
obtaining a plurality of overall costs according to the first cost score, the plurality of second cost scores and the third cost score; and
determining a minimum overall cost as the minimum cost of the action node, and determining the minimum cost path corresponding to the minimum cost.

5. The method as claimed in claim 4, wherein obtaining a plurality of overall costs according to the first cost score, the plurality of second cost scores and the third cost score comprises:
determining a penalty cost as a fourth cost score in response to a repeatability constraint being met; and
obtaining the plurality of overall costs according to the first cost score, the plurality of second cost scores, the third cost score and the fourth cost score.

6. The method as claimed in claim 5, wherein the repeatability constraint comprises:
dance action segments corresponding to at least two identical music feature segments are different;
or, dance action segments corresponding to at least two different music feature segments are identical within a preset interval range.

7. The method as claimed in claim 4, 5 or 6, wherein the matching cost comprises at least one of an intensity matching cost, a duration matching cost, and a style matching cost, and determining the matching cost corresponding to the Nth music feature segment comprises at least one of the followings:
determining an action intensity of the dance action segment corresponding to the action node and a music intensity of the Nth music feature segment;
determining an intensity matching cost corresponding to the Nth music feature segment according to the action intensity and the music intensity; and,
determining an action duration of the dance action segment corresponding to the action node and a music duration of the Nth music feature segment;
determining a duration matching cost corresponding to the Nth music feature segment according to the action duration and the music duration; and,
determining an action style of the dance action segment corresponding to the action node and a music style of the Nth music feature segment; and
determining a style matching cost corresponding to the Nth music feature segment according to the action style and the music style.

8. The method as claimed in claim 7, wherein the dance action segment comprises a first dance action segment and a second dance action segment, the first dance action segment corresponds to music style information, and the action style is determined by adopting the following manners:
determining an action style of the first dance action segment according to the music style information;
clustering the first dance action segment according to the action style to obtain a plurality of action clusters; and
determining a target action cluster corresponding to the second dance action segment, and taking an action style corresponding to the target action cluster as an action style of the second dance action segment.

9. The method as claimed in claim 1, wherein establishing the animation state transition relationship for the plurality of dance action segments comprises:
establishing action nodes corresponding to the plurality of dance action segments;
determining the transition cost existing among the action nodes; and
obtaining the animation state transition relationship for the plurality of dance action segments according to a connection relationship, which is established between the action nodes whose transition cost is larger than a preset transition cost.

10. The method as claimed in claim 1, wherein generating a dance animation for the target audio file according to the dance action sequence comprises:
in response to footsteps of the dance action segments in the dance action sequence being in a specified state, performing footstep correction on the dance action segments,
the specified state comprising:
both feet slide on the ground, or one foot slides on the ground while the other foot is not fixed on the ground.

11. The method as claimed in claim 1, further comprising:
acquiring original dance action data; and
determining action rhythm point features in the original dance action data, and segmenting the original dance action data according to the action rhythm point features to obtain the plurality of dance action segments.

12. The method as claimed in claim 11, wherein the action rhythm point features comprise at least one of the following:
a joint weighted angular velocity curve, a joint trajectory curve, and a footstep height curve.

13. The method as claimed in claim 11 or 12, wherein the original dance action data comprises first original dance action data and second original dance action data, and acquiring the original dance action data comprises:
acquiring the first original dance action data; and
performing action expansion according to the first original dance action data to obtain the second original dance action data.

14. The method as claimed in claim 13, wherein the action expansion is performed by adopting the following manners:
action mirroring, action fusion and action curve control.

15. (canceled)

16. An electronic device, comprising a processor, a memory and a computer program that is stored on the memory and runnable on the processor, wherein the computer program, when executed by the processor, implements the steps of the dance animation processing method according to any one of claims 1 to 14.

17. A non-transitory storage medium, having a computer program stored thereon, wherein the computer program, when executed by a processor, implements the steps of the dance animation processing method according to any one of claims 1 to 14.
